(19) United States
(12) Patent Application Publication
(10) Pub. No.: US 2001/0014141 A1
(43) Pub. Date: Aug. 16, 2001

(54) Method for modifying the operating system of a telecommunication terminal device

(76) Inventors: Gerald Kraeutler, Wien (AT); Farrokh Mohammadzadeh, Wien (AT); Mohammad Vizaei, Wien (AT)

Correspondence Address: Schiff Hardin & Waite, Patent Department, 6600 Floor Sears Tower, 233 South Wacker Drive, Chicago, IL, 60606, US

(21) Appl. No.: 09/734,938

(22) Filed: Dec. 11, 2000

(30) Foreign Application Priority Data
Dec. 9, 1999 (DE) 19959434.1

(51) Int. Cl. H04M 1/24; H04M 3/08

(52) U.S. Cl. 379/1.03; 455/67.1

(57) ABSTRACT

In a telecommunication network having a data management system, a method for modifying the operating system of a telecommunication terminal device connected to the network. An operating system modified according to the method allows the telecommunication terminal device to check for errors in a data transmission. If an error in the data transmission is found, connection between the terminal device and the network's data management system is aborted, a new connection between the terminal device and the network's data management system is made, and the data transmission is repeated.

### BACKGROUND OF THE INVENTION

1. Field of the Invention

The present invention is generally directed to a telecommunication terminal device. In particular, the present invention is directed to modifying an operating system used in a telecommunication terminal device.

2. Description of the Related Art

In order to meet the increasing and rapidly changing demands made of telecommunication terminal devices, there is a need to make the terminal devices more reliable and adaptive to advances in technology. Often this is done by modifying or completely replacing the operating system used in the telecommunication terminal device. Such modification or replacement allows the telecommunication terminal device to remain useful to the user for a greater period of time and through several advances in technology.

Also, as telecommunication terminal devices are increasingly more involved in the transmission of data over a telecommunication network, proper modification of the operating system used by the telecommunication terminal device would make such data transmission easier.

A constant connection between a telecommunication terminal device and a telecommunication network that carries data is necessary in order to ensure reliable transfer of the data over the network to the telecommunication terminal device. However, as can well be appreciated, a constant connection cannot be assured for the entire duration of the data transmission due to the ever increasing burden placed on communication networks, and previously known methods of verifying data transmission do not offer a way to take an interruption of the connection into consideration or correct errors in the data transmission that thereby occur. This can be a major problem and source of frustration for both the sender of the data as well as for the intended recipient.

Moreover, operating systems used by telecommunication terminal devices have been known to fail occasionally, and any telecommunication terminal device on which an operating system has failed makes the terminal device no longer functional. Hence, the terminal device must be handed over to the manufacturer for repair or a replacement for the device must be made. In the case of repair, even under the best of circumstances, the manufacturer can restore the malfunctioning telecommunication terminal device to near factory-new condition. However, the repair process involves great inconvenience for the user of the telecommunication terminal device, since comparatively long processing times are usually experienced. Further, the telecommunication terminal device must be transported over relatively great distances due to the increasing centralization of the manufacturers. In the case of replacement, the user of the telecommunication terminal device would probably incur an undesired and untimely capital expenditure. In either event, repair or replacement, failure of the operating system in a telecommunication terminal device is an unpleasant and unwelcome inconvenience to the user.

Therefore, in order to overcome all of these shortcomings, the present invention offers an inexpensive, dependable and convenient way for modifying the operating system of a telecommunication terminal device, as well as for allowing the telecommunication terminal device to check for errors in a data transmission and correct any errors found.

### SUMMARY OF THE INVENTION

It is an object of the present invention to provide a method for modifying the operating system of a telecommunication terminal device.

It is a another object of the present invention to provide a method for checking the correctness of data transmitted over a telecommunications network.

It is a further object of the present invention to provide a method for correcting errors in a data transmission, even if the error is attributed to an interruption of a telecommunications connection.

It is an additional object of the present invention to provide a method for periodically repeating a data transmission so that the current status of the operating system can be verified.

It is yet another object of the present invention to provide a method for monitoring a data transmission by forming and checking a checksum derived from the transmitted data.

It is yet a further object of the present invention to provide a method for checking the correctness of a data transmission with the assistance of the operating system running on the telecommunication terminal device.

It is yet an additional object of the present invention to provide a method for not overwriting the entire memory area used by the operating system of a telecommunication terminal device during a data transmission.

It is still another object of the present invention to provide a method for data transmission having high degree of reliability.

These and other objects of the present invention will become apparent upon careful review of the following disclosure, which is to be read in conjunction with review of the accompanying drawing figure.

### BRIEF DESCRIPTION OF THE DRAWING

FIG. 1 shows a block diagram of a memory area according to the present invention.

### DETAILED DESCRIPTION OF THE PREFERRED EMBODIMENTS

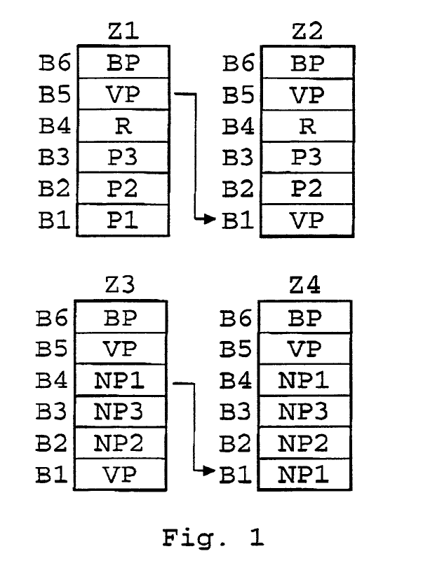

FIG. 1 shows, in block diagram form, the division of a memory area used for the operating system of a telecommunication terminal device and the conditions of the memory area during the loading of a modified operating system according to the present invention.

The memory area is divided into six memory blocks B1, B2, B3, B4, B5, B6, each memory block being of equal size to the others. First through third memory blocks B1, B2, B3 contain first through third program parts P1, P2, P3, respectively. A reserved memory R is situated in the fourth memory block B4. The fifth memory block B5 contains a connection program part VP which is needed for the connection setup. Finally, a boot program BP is located in the sixth memory block B6. This occupancy of the memory area is referred to as first condition Z1.

The user of the telecommunication terminal device selects the access number of the data management center, such as by dialing into, and subsequently starts the data transfer. At first, the connection program VP from the sixth memory block B6 is copied into the first memory block B1. This occupancy of the memory area is referred to as second condition Z2. Subsequently, a second new program part NP2 is transmitted into the second memory block B2, a third new program part NP3 is transmitted into the third memory block B3. Then, a first new program part NP1 is transmitted into the fourth memory block B4. This memory occupancy is referred to as third condition Z3. Last, the first new program part NP1 is copied into the first memory block B1. The memory occupancy resulting therefrom is referred to as a fourth condition Z4.

To begin, the user of the telecommunication terminal device initiates a restart of the operating system. The program execution begins with the boot program BP with which the correctness of the newly loaded program parts NP1, NP2, NP3 is determined by the formation and comparison of a checksum.

In the absence of an error as determined by the proper comparison of the checksum, further program execution is continued at the first memory block B1 and at the first new program part NP1. In the case of an error, the correctness of the connection program VP is determined by forming and comparing a checksum.

If the outcome of this check reveals no errors, then the connection program is copied into the first memory block B1 and the program execution is again continued at the first memory block B1, both in the third condition Z3 as well as in the second condition Z2. After which, a branch is made to the connection program VP with the boot program BP. This results in a renewed connection setup to the data management center and another data transmission. The steps of this sequence are repeated until a correct version of the new program parts NP1, NP2, NP3 has been communicated into the memory of the telecommunication terminal device. These basic component parts are all that are needed for checking for errors in the data transmission.

Basic elements of the operating system are safely stored in protected memory areas of the telecommunication terminal device. Thus, the entire memory area containing the operating system is not overwritten by the data transmission and a falsification of the corresponding data is prevented.

A copy of at least a part of the operating system is compiled before the data transfer is completed. In addition, the operating system modified by the data transfer is activated only when the data transmission is correct. In this way, a faulty version of the operating system is presented from being communicated to the telecommunication terminal device due to an incorrect data transmission. Over and above this, a correct, although not updated, version of the operating system can be accessed and faultless function of the telecommunication terminal device can be assured. According to the present invention, this simple procedure is all that is needed for checking a data transmission over a telecommunication network using the telecommunication terminal device.

The data management center expects an answerback from the telecommunication terminal device regarding the correctness of the data transmission and restarts the data transmission after a predetermined time if the answerback is not received. Although the data management center fails to receive an answerback from the telecommunication terminal device regarding the correctness of the data transmission, it is the telecommunication terminal device that requests that the data management center retransmit the data. Therefore, only the telecommunication terminal device is needed to detect an error in transmission and to have a repeat of the data transmission initiated. Also, initiation of a renewed data transmission is also possible even in the event of nearly complete destruction of the operating system.

Once a data transmission is undertaken, the transmission is repeated periodically. In this way, the current status of the operating system is also transmitted into the data memory of the telecommunication terminal device. Monitoring the data transmission is therefore accomplished by forming and checking a checksum derived from the communicated data.

A connection between the telecommunication terminal device and the data management center is established with the assistance of the operating system running in the telecommunication terminal device. In this case, a decision is be made by the telecommunication terminal device as to whether a connection is necessary. If a connection is necessary, one can be established as warranted. If a determination is made not to establish a connection, the telecommunication terminal device assumes a stand-by mode in preparation for the next data transmission that may require a connection.

An operating system modified according to the present invention permits the correctness of transmitted data to be checked locally in the telecommunication terminal device without involving the data management center. This centralized approach, assures that the burden of checking for errors in a data transmission is taken away from both the data management center, as well as the telecommunication network. This is true, because as explained above, only a minimum amount of data need be transmitted to the telecommunication terminal device in order to check for errors in the transmission.

When the correctness of the data transmission is checked and the data transmission is repeated, as in the case of error, the first connection is aborted and a new connection is set up between the telecommunication terminal device and the data management center of the telecommunication network. This occurs even if the error is attributed to an interruption of the connection between the telecommunication network and the telecommunication terminal device are taken into consideration and corrected. As can readily be appreciated, interruption in a connection cannot be entirely precluded given the current state of the art of the telecommunications.

The present invention is capable of modifying programs which are needed for processing communication protocols such as calling line identification restriction (CLIR), call-waiting (CW) and call-back-when-busy (CCBS) that are normally found in the operating system of a telecommunication terminal device.

The present invention is useful with respect to telecommunication network transmission of voice, such as using Internet protocol. Such IP telephony is very attractive to user of telecommunication terminal devices due to the growing burden placed upon classic voice networks because of the increase in traffic over these networks. When used for an IP telephony transmission, the present invention regards the digitized voice signal as the data transmission, as discussed above.

The present invention is also useful when an integrated services digital network (ISDN) telephone is used as the telecommunication terminal device. This is because an ISDN telephone enables a plurality of desirable services to be made available to the user. In which case, the present invention gives the user the opportunity to easily modify the operating system of the ISDN telephone, as well as to check for errors in data transmission.

The present invention is also useful when a personal communications service (PCS) telephone, a wireless telephone, a cellular telephone, or other such mobile telephone is used as the telecommunication terminal device. Even more than in the case of the use of an ISDN telephone, the function and usefulness of these devices is determined by rapidly changing user demands. Thus, the present invention is suitable for implementing desirable and necessary modifications to the operating system of these types of telephones, as well as to check for errors in data transmission.

Although preferred embodiments of the invention have been described herein, it is to be understood that the invention is not limited to these embodiments, and that various changes and modifications thereto may be made without departing from the scope or spirit of the invention, which is defined by the following claims.

We claim:

1. A method for transmitting data in a telecommunication network in communication with a telecommunication terminal device, the method comprising the steps of:
administering operating system data for an operating system running in the telecommunication terminal device, in a data management system remote from said telecommunication terminal device;
establishing a connection for transmitting data, including said operating system data, between the telecommunication terminal device and the data management system;
transmitting the operating system data from said data management system to a memory area of the operating system running in said telecommunication terminal device;
checking the correctness of the data transmitted in the telecommunication terminal device;
aborting the connection in case of error;
establishing another connection between the telecommunication terminal device and the data management system; and
repeating transmission of said operating system data from said data management system to said terminal device.

2. The method of claim 1, wherein the step of establishing a connection comprises requesting the assistance of the operating system running in the telecommunication terminal device.

3. The method of claim 2, wherein the step of checking comprises forming and checking a checksum derived from the transmitted data.

4. The method of claim 3, wherein the step of checking further comprises requesting the assistance of the operating system running in the telecommunication terminal device.

5. The method according to claim 4, wherein the step of repeating transmission comprises repeating the data transmission periodically.

6. The method of claim 1, further comprising the step of modifying the operating system running in the telecommunication terminal device.

7. The method of claim 1, further comprising the step of storing at least a part of the operating system data in the memory area of the operating system.

8. The method of claim 7, wherein the step of storing comprises ensuring that the operating system is not overwritten by the transmitted operating system data.

9. The method of claim 1, further comprising the step of accepting in the data management system an answerback from the telecommunication terminal device regarding the correctness of the data transmission.

10. The method of claim 1, wherein the step of checking further comprises accepting in the data management center an answerback from the telecommunication terminal device regarding the correctness of the data transmission and repeating the data transmission after a predetermined time upon the occurrence of an error in the data transmission.

11. The method of claim 1, wherein the step of establishing a connection comprises connecting to an ISDN telephone.

12. The method of claim 1, wherein the step of establishing a connection comprises connecting to a mobile telephone.

13. The method of claim 1, wherein the step of transmitting comprises compiling a copy of at least a part of the operating system.

14. The method of claim 6, wherein the step of modifying further comprises activating the modified operating system given the correctness of the data transmission.
